(19) United States
(12) Patent Application Publication
(10) Pub. No.: US 2015/0067623 A1
(43) Pub. Date: Mar. 5, 2015

(54) TIMING ANALYSIS METHOD FOR NON-STANDARD CELL CIRCUIT AND ASSOCIATED MACHINE READABLE MEDIUM

(71) Applicant: REALTEK SEMICONDUCTOR CORP., HsinChu (TW)

(72) Inventors: Ying-Chieh Chen, Keelung City (TW); Mei-Li Yu, Taoyuan County (TW); Ting-Hsiung Wang, Kaohsiung City (TW); Yu-Lan Lo, Hsinchu County (TW); Shu-Yi Kao, Hsinchu County (TW)

(21) Appl. No.: 14/450,279

(22) Filed: Aug. 3, 2014

(30) Foreign Application Priority Data
Sep. 5, 2013 (TW) 102132041

(51) Int. Cl. G06F 17/50

(52) U.S. Cl. CPC G06F 17/5031; G06F 2217/84
USPC 716/108

(57) ABSTRACT

A timing analysis method applied for a non-standard cell circuit, includes: identifying at least a first register and a second register from the circuit; calculating at least one path delay of at least one path between the first register and the second register; calculating a first register clock delay from a first clock source to a first register clock input terminal of the first register; calculating a second register clock delay from a second clock source to a second register clock input terminal of the second register; and determining whether timing violation takes place in respect of the second register according to the path delay, the first register clock delay, the second register clock delay, and a first register delay of the first register.

### BACKGROUND OF THE INVENTION

1. Field of the Invention

The disclosed embodiments of the present invention relate to a circuit design verification method, and more particularly, to a timing analysis method which is applicable to a non-standard cell circuit.

2. Description of the Prior Art

For an analog circuit consisting of non-standard cells, a conventional verification process requires a fully functional simulation with respect to the overall circuit, wherein as many test patterns as possible are inputted to the circuit to verify the main functions of the circuit. Functional simulation consumes time and may be imperfect, however. Efficiency-oriented designers may therefore give up complete timing verification.

In light of the above, there is an urgent need for a novel timing analysis method which takes both efficiency and test coverage into account to improve upon the above-mentioned issues.

### SUMMARY OF THE INVENTION

One of the objectives of the present invention is to provide a timing analysis method which is applicable to a non-standard cell circuit.

According to an exemplary embodiment of the present invention, a timing analysis method applied to a non-standard cell circuit is disclosed. The timing analysis method comprises: identifying at least a first register and a second register from the circuit, wherein there is at least a path between the first register and the second register, and the path is from a first register data output of the first register to a second register data input of the second register; calculating a path delay of the path; calculating a first register clock delay from a first clock source to a first register clock input of the first register, and calculating a second register clock delay from a second clock source to a second register clock input of the second register; and determining whether a timing violation takes place within the second register according to the path delay, the first register clock delay, the second register clock delay, and a first register delay of the first register.

According to an exemplary embodiment of the present invention, a non-transitory machine readable medium is disclosed, wherein the non-transitory machine readable medium stores a program code, and when executed by a processor, the program code enables the processor to perform a multiple defect diagnosis method. The method comprises: identifying at least a first register and a second register from the circuit, wherein there is at least a path between the first register and the second register, and the path is from a first register data output of the first register to a second register data input of the second register; calculating a path delay of the path; calculating a first register clock delay from a first clock source to a first register clock input of the first register, and calculating a second register clock delay from a second clock source to a second register clock input of the second register; and determining whether a timing violation takes place within the second register according to the path delay, the first register clock delay, the second register clock delay, and a first register delay of the first register.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a circuit including non-standard cells.

FIG. 2 is a flowchart illustrating a timing analysis method applied to a non-standard cell circuit according to an exemplary embodiment of the present invention.

FIG. 3 is a diagram illustrating a computer system for performing the timing analysis method mentioned above according to an exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “coupled” is intended to mean either an indirect or direct electrical connection. Accordingly, if one device is coupled to another device, that connection may be through a direct electrical connection, or through an indirect electrical connection via other devices and connections.

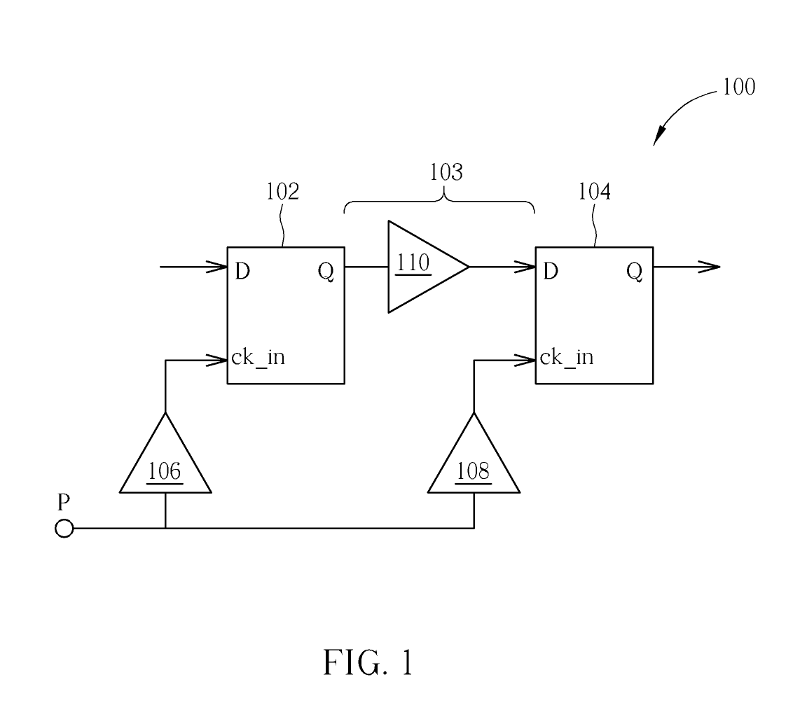

FIG. 1 is a diagram illustrating a circuit 100 including non-standard cells. For illustrative purposes, FIG. 1 only depicts a portion of a complete circuit, such as a plurality of registers 102, 104 and a plurality of combinational circuits 106, 108 and 110. Please note that circuit 100 may include analog circuits or any other circuits comprising components which are not provided by a standard cell library. In other words, the circuit 100 includes non-standard cells, and the combination circuits 106, 108 and 110 may comprise transistors, basic logical gates (e.g. AND gates and OR gates) or logic circuit consisting of basic logical gates. Further, the combination circuits 106, 108 and 110 may be different from each other, and the registers 102 and 104 may be registers belong to any category, e.g. a D-latch or a D-flip flop.

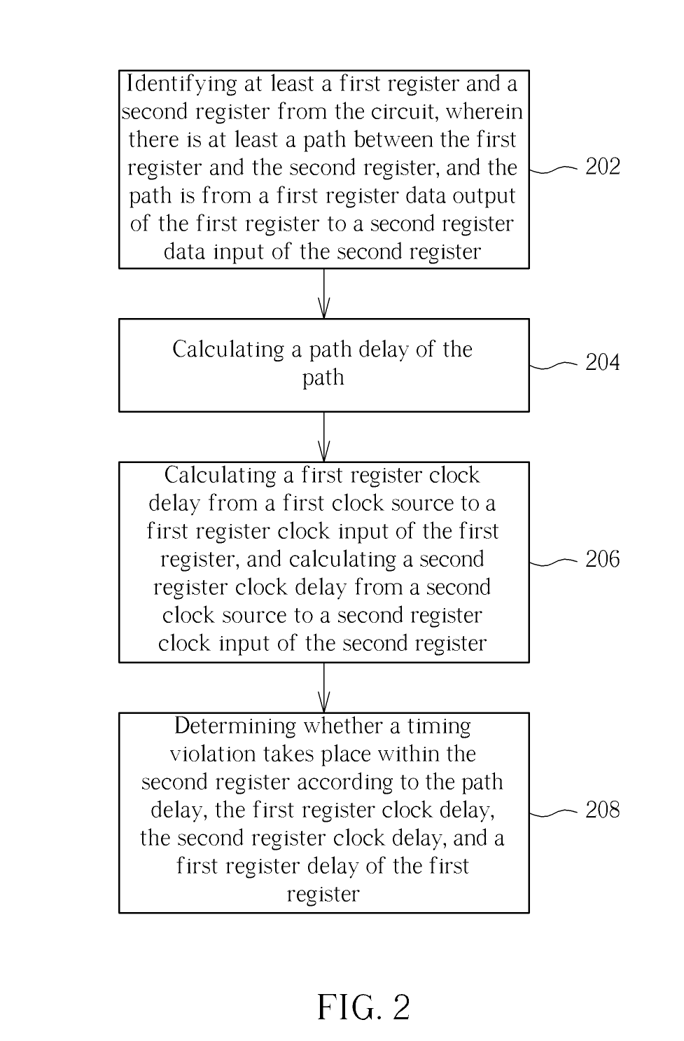

Please refer to FIG. 2 in conjunction with FIG. 1. FIG. 2 is a flowchart illustrating a timing analysis method applied to a non-standard cell circuit according to an exemplary embodiment of the present invention. Provided that substantially the same result is achieved, the steps in FIG. 2 need not be in the exact order shown and need not be contiguous; that is, other steps can be intermediate. Some steps in FIG. 2 may be omitted according to various embodiments or requirements. Details of the timing analysis method are described as follows.

Step 202: identifying at least a first register and a second register from the circuit, wherein there is at least a path between the first register and the second register, and the path is from a first register data output of the first register to a second register data input of the second register;

Step 204: calculating a path delay of the path;

Step 206: calculating a first register clock delay from a first clock source to a first register clock input of the first register, and calculating a second register clock delay from a second clock source to a second register clock input of the second register; and

Step 208: determining whether a timing violation takes place within the second register according to the path delay, the first register clock delay, the second register clock delay, and a first register delay of the first register.

In step 202, all or a portion of the registers within the non-standard cell circuit are identified according to the required test coverage or analysis range, and the method of identifying the registers is not limited. For example, this embodiment preferably utilizes a specific register identification method which identifies the registers from the circuit 100 according to connections between transistors. Supposing the target analysis range of the circuit 100 is registers 102 and 104, then registers 102 and 104 can be identified according to the connections between transistors of a transistor level netlist of the circuit 100. Next, it is necessary to identify whether there is at least a path between the register 102 and the register 104, wherein the path starts from a data output Q of the register 102 to a data input D of the register 104 (e.g. a path 103 in FIG.

In step 204, a path delay of the path between the register 102 and the register 104 is derived. For FIG. 1, a path delay of the path 103 is derived. An analog circuit simulation software may be used to perform simulation upon the path 103 to calculate the path delay, which dramatically reduces the simulation time.

In step 206, a first clock delay from a clock source P to a clock input ck_in of the register 102 is calculated; in addition, a second clock delay from the clock source P to a clock input ck_in of the register 104 is calculated also. Please note that in other embodiments there may be more than one clock source.

Lastly, it is determined whether a setup time violation or a hold time violation takes place within the register 104 according to specifications of data setup time and hold time of the register 104, the path delay of the path 103, the first clock delay, the second clock delay and a register delay of the register 102, i.e. step 208. Those skilled in the art will readily understand the identification of the setup time violation or the hold time violation, and further description is therefore omitted here for brevity.

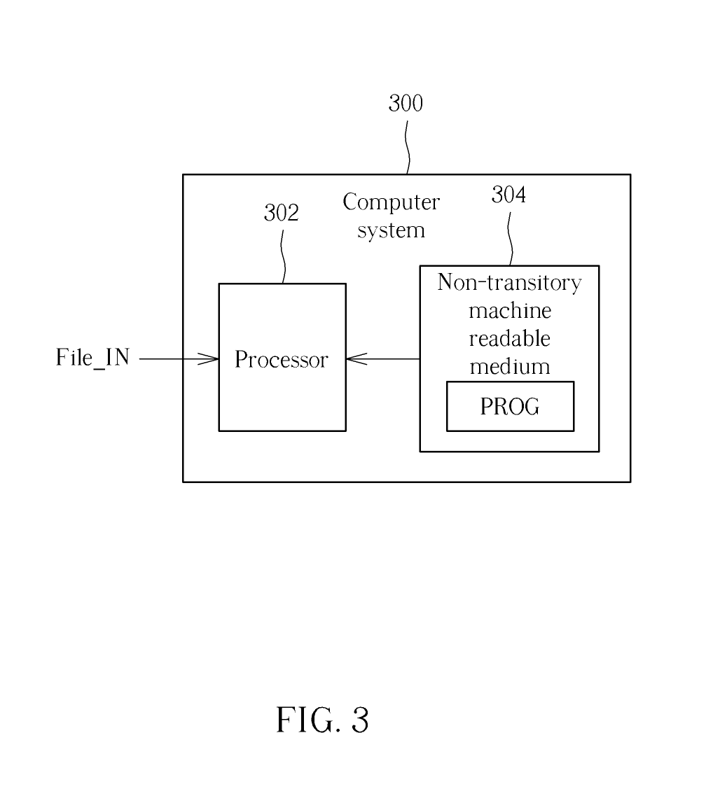

Please refer to FIG. 3, which is a diagram illustrating a computer system 300 for performing the timing analysis method mentioned above according to an exemplary embodiment of the present invention. The computer system 300 includes a processor 302 and a non-transitory machine readable medium 304. The computer system 300 could be a personal computer, and the non-transitory machine readable medium 304 could be any storage device capable of storing data in a personal computer, e.g. a volatile memory, non-volatile memory, hard disk or CD-ROM. In this embodiment, the non-transitory machine readable medium 304 stores a program code PROG, wherein when the program code PROG is loaded and executed by the processor 302, the program code PROG enables the processor to perform the timing analysis method (i.e. the steps 202 to 208 shown in FIG. 2) upon a circuit design file File_IN of an integrated circuit. Those skilled in the art will readily understand the timing analysis method performed by making the processor 302 execute the program code PROG after reading the above paragraphs; further description is therefore omitted here for brevity.

Compared with the conventional methods, the timing analysis method disclosed herein performs timing analysis upon the identified path between register pairs in a non-standard cell circuit, which takes both efficiency and test coverage into account.

Those skilled in the art will readily observe that numerous modifications and alterations of the device and method may be made while retaining the teachings of the invention. Accordingly, the above disclosure should be construed as limited only by the metes and bounds of the appended claims.

1. A timing analysis method applied to a non-standard cell circuit, comprising:
identifying at least a first register and a second register from the circuit, wherein there is at least a path between the first register and the second register, and the path is from a first register data output of the first register to a second register data input of the second register;
calculating a path delay of the path by using a computer;
calculating a first register clock delay from a first clock source to a first register clock input of the first register, and calculating a second register clock delay from a second clock source to a second register clock input of the second register; and
determining whether a timing violation takes place within the second register according to the path delay, the first register clock delay, the second register clock delay, and a first register delay of the first register.

2. The method of claim 1, wherein the step of calculating the path delay of the path comprises:
deriving a component delay of a component within the path; and
calculating the path delay of the path according to the component delay.

3. The method of claim 1, wherein the step of determining whether a timing violation takes place within the second register according to the path delay, the first register clock delay, the second register clock delay, and the first register delay of the first register comprises:
determining whether a setup time violation or a hold time violation takes place within the second register according to specifications of data setup time and hold time of the second register, the path delay, the first register clock delay, the second register clock delay and the first register delay of the first register.

4. The method of claim 1, wherein the step of identifying the first register and the second register from the circuit comprises:
identifying the first register and the second register from the circuit according to connections between transistors within the circuit.

5. A non-transitory machine readable medium storing a program code, wherein when executed by a processor, the program code enables the processor to perform a timing analysis method applied to a non-standard cell circuit, the method comprising:
identifying at least a first register and a second register from the circuit, wherein there is at least a path between the first register and the second register, and the path is from a first register data output of the first register to a second register data input of the second register;
calculating a path delay of the path;
calculating a first register clock delay from a first clock source to a first register clock input of the first register, and calculating a second register clock delay from a second clock source to a second register clock input of the second register; and
determining whether a timing violation takes place within the second register according to the path delay, the first register clock delay, the second register clock delay, and a first register delay of the first register.

6. The non-transitory machine readable medium of claim 5, wherein the step of calculating the path delay of the path comprises:
deriving a component delay of a component within the path; and
calculating the path delay of the path according to the component delay.

7. The non-transitory machine readable medium of claim 5, wherein the step of determining whether a timing violation takes place within the second register according to the path delay, the first register clock delay, the second register clock delay, and the first register delay of the first register comprises:
determining whether a setup time violation or a hold time violation takes place within the second register according to specifications of data setup time and hold time of the second register, the path delay, the first register clock delay, the second register clock delay and the first register delay of the first register.

8. The non-transitory machine readable medium of claim 5, wherein the step of identifying the first register and the second register from the circuit comprises:
identifying the first register and the second register from the circuit according to connections between transistors within the circuit.
